(19) United States
(12) Patent Application Publication
(10) Pub. No.: US 2019/0000023 A1
(43) Pub. Date: Jan. 3, 2019

(54) IRRIGATION SPRINKLER

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD.

(21) Appl. No.: 15/639,178

(22) Filed: Jun. 30, 2017

(51) Int. Cl. A01G 25/09; B05B 3/02; A01G 25/16

(52) U.S. Cl. CPC A01G 25/092; A01G 25/00; A01G 25/162; B05B 3/02

(57) ABSTRACT

An irrigation sprinkler may comprise a sprinkler, a connecting base, an operating member, a driving lever, and a locating unit. A protruding portion protruding from a central portion of a top surface of the operating member has an arc-shaped top end to form two abutting surfaces at two sides of the arc. Moreover, one of the two abutting surfaces is configured to be abutted by the driving lever when the irrigation sprinkler changes the rotating direction. The driving lever has a first portion, a second portion, and a third portion, and a bottom end of the third portion has an upward recess formed at a central portion thereof. The recess of the third portion of the driving lever is configured to cover the protruding portion completely, which improves the driving actions between the driving lever and the operating member.

### FIELD OF THE INVENTION

The present invention relates to an irrigation sprinkler, and more particularly to an auto reverse irrigation sprinkler.

### BACKGROUND OF THE INVENTION

Referring to FIG. 9 or European Union Patent EP0826427A2, one kind of the conventional irrigation sprinkler comprises a sprinkler (60) which has two water outlet tubes (601), and a control base (61) is pivotally installed between the two water outlet tubes (601) to enable a horizontal board of the control base (61) to have seesaw moves and alternatively block top ends of the two water outlet tubes (601). Moreover, a top end of the control base (61) is connected to a control lever (62), and an upper portion of the control lever (62) penetrates through a locating opening (602). Furthermore, a spring (63) is disposed on a lower portion of the control lever (62) to bear against the horizontal board. When the irrigation sprinkler is started and water flows in, the control lever (62) is driven by a power unit to move between two edges of the locating opening (602), wherein the power unit can drive the control lever (62) toward a direction and also change direction when the control lever (62) touches either of the edges of the locating opening (602). Simultaneously, the spring (63) is driven by the control lever (62) to have synchronous movements and to enable the horizontal board to alternatively block the two water outlet tubes (601), thereby changing the direction of spraying water.

However, the above conventional irrigation sprinkler is disadvantageous because: (i) the spring (63) is needed to dispose on the control lever (62), which increases the costs and difficulty of installation; and (ii) the spring (63) is prone to rusting when soaking in water over a long period of time.

Referring to FIG. 10 or Taiwan Patent No. I273883, another kind of conventional irrigation sprinkler comprises a control unit (70) which is configured to rotate a spraying nozzle to achieve different spraying directions. A gear set having an impeller, an operating member (72), and an operating base (73) having a water switch device, are installed inside the control unit (70) and moved cooperatively. A bottom surface of the operating base (73) comprises two sealing surfaces (731) respectively at two lateral sides thereof, and the sealing surfaces (731) are respectively aligned with two water outlet holes (711) of a connecting base (71). In actual application, the operating base (73) can have seesaw moves to enable the sealing surfaces (731) to alternatively block the two corresponding water outlet holes (711). Moreover, a top surface of the operating base (73) has a recess to form a limiting space (733), and two lateral inner surfaces of the limiting space (733) are formed into two pushing surfaces (732). The operating member (72) further has a lever (721) formed at a lower portion thereof and configured to insert into the limiting space (733) of the operating base (73). In addition, a pushing rod (722) formed at an upper portion of the operating member (72) is adapted to drive the lever (721) to have movements synchronously. The irrigation sprinkler also has a limiting adapter to control rotating distance of the spraying nozzle. When the irrigation sprinkler is started, the pushing rod (722) driven by the limiting adapter is configured to move the lever (721) in either direction to couple with the pushing surface (732), thereby driving the sealing surface (731) at the same side to block the corresponding water outlet hole (711).

However, the above conventional irrigation sprinkler is still disadvantageous because: (i) the limiting space (733) of the operating base (73) cannot cover around the whole lever (721), which lowers the effect of driving movements; (ii) the lever (721) is coupled with either of the two pushing surfaces (732) of the operating base (73) through two lateral sides thereof, which has a low mechanical sensitivity and is easy to have parts stuck. Therefore, there remains a need for a new and improved design for an irrigation sprinkler to overcome the problems presented above.

### SUMMARY OF THE INVENTION

The present invention provides an irrigation sprinkler which comprises a sprinkler, a connecting base, an operating member, a driving lever, and a locating unit. The sprinkler has a bottom cover and a top shell which can be vertically fit together, and a water inlet connector is formed at a central portion of the bottom cover for water inflow. Moreover, when the bottom cover and the top shell fit together, an accommodating space is formed therebetween to install the connecting base. The connecting base comprises an impeller and a gear set which are respectively formed at a bottom surface and a top surface thereof and are configured to engage with each other to have synchronous movements. A top end of the top shell is connected and communicated with the locating unit through a through hole, and the locating unit is adapted to be driven by the gear set to have rotating movement. Furthermore, the locating unit comprises at least two locating grooves having an overlapped area to control a maximum rotating angle of the irrigation sprinkler when spraying water, and a water outlet connector is formed at a top end of the locating unit for water outflow. The connecting base further has a first water channel and a second water channel penetrating therethrough and located adjacent to each other, and two pivotal bases are formed therebetween and respectively at two lateral sides of the first water channel and the second water channel to pivotally connect the operating member thereon. The operating member is pivotally connected to the two pivotal bases through two bumps at two lateral edges thereof, and a protruding portion protrudes from a central portion of a top surface of the operating member between the two bumps. Moreover, the protruding portion has an arc-shaped top end to form two abutting surfaces at two sides of the arc, and one of the two abutting surfaces is configured to be abutted by the driving lever when the irrigation sprinkler changes the rotating direction. Moreover, with the arc-shaped abutting surfaces, the operating member driven by the driving lever can be moved smoothly and sensitively. The driving lever has a first portion, a second portion, and a third portion, which are connected sequentially from top to bottom, and a flange is formed between the first portion and the second portion. Moreover, a sealing ring is disposed on the driving lever from a top portion thereof to couple with the flange, and a bottom end of the third portion has an upward recess formed at a central portion thereof. The diameter of the recess is gradually wider from top to bottom to form two inclined surfaces at two lateral inner surfaces thereof. The sealing ring is configured to couple with an inner wall of the through hole, and the first portion of the driving lever sequentially penetrates through the through hole and the overlapped area of the locating grooves. The sealing ring in the top shell is configured to limit the position of the driving lever and to provide the sealing effect. Additionally, the protruding portion of the operating member is fully covered by the recess of the third portion of the driving lever, and when the irrigation sprinkler is not used, the protruding portion has no contact with the recess to form a separating space therebetween.

Comparing with conventional irrigation sprinkler, the present invention is advantageous because: (i) the driving lever can be used without a spring, which simplifies the structure, lowers the cost and clears up the worries on rusty spring; (ii) the recess of the third portion of the driving lever completely covers the protruding portion, which improves the driving actions between the driving lever and the operating member; and (iii) the protruding portion contacts the inclined surfaces through the arc-shaped abutting surface, which enables the operating member to be driven by the driving lever more smoothly, further improving the sensitivity of the irrigation sprinkler when changing rotating direction and preventing parts stuck.

### BRIEF DESCRIPTION OF THE DRAWINGS

FIG. 1 is a three-dimensional assembly view of an irrigation sprinkler in the present invention.

FIG. 2 is a three-dimensional exploded view of the irrigation sprinkler in the present invention.

FIG. 3 is a sectional assembly view of the irrigation sprinkler in the present invention.

FIG. 4 is a sectional assembly view from another angle illustrating the irrigation sprinkler of the present invention rotates in a first direction.

FIG. 5 is a partial enlarged view of FIG. 4.

FIG. 6 is a sectional assembly view illustrating a contacting pattern between an operating member and a driving lever of the present invention when the irrigation sprinkler changes the rotating direction.

FIG. 7 is a partial enlarged view of FIG. 6.

FIG. 8 is a schematic view illustrating the irrigation sprinkler of the present invention rotates in the other direction.

FIG. 9 is a prior art.

FIG. 10 is a prior art.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

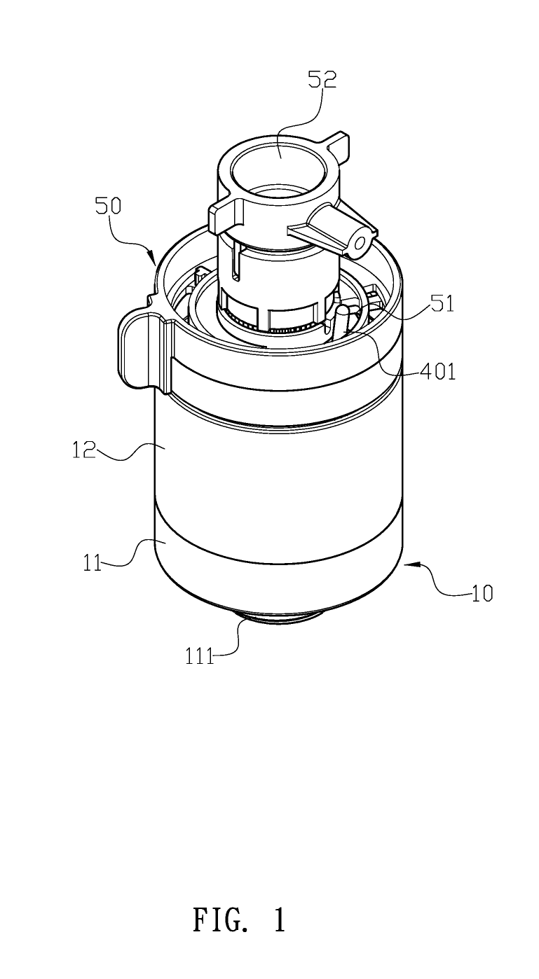

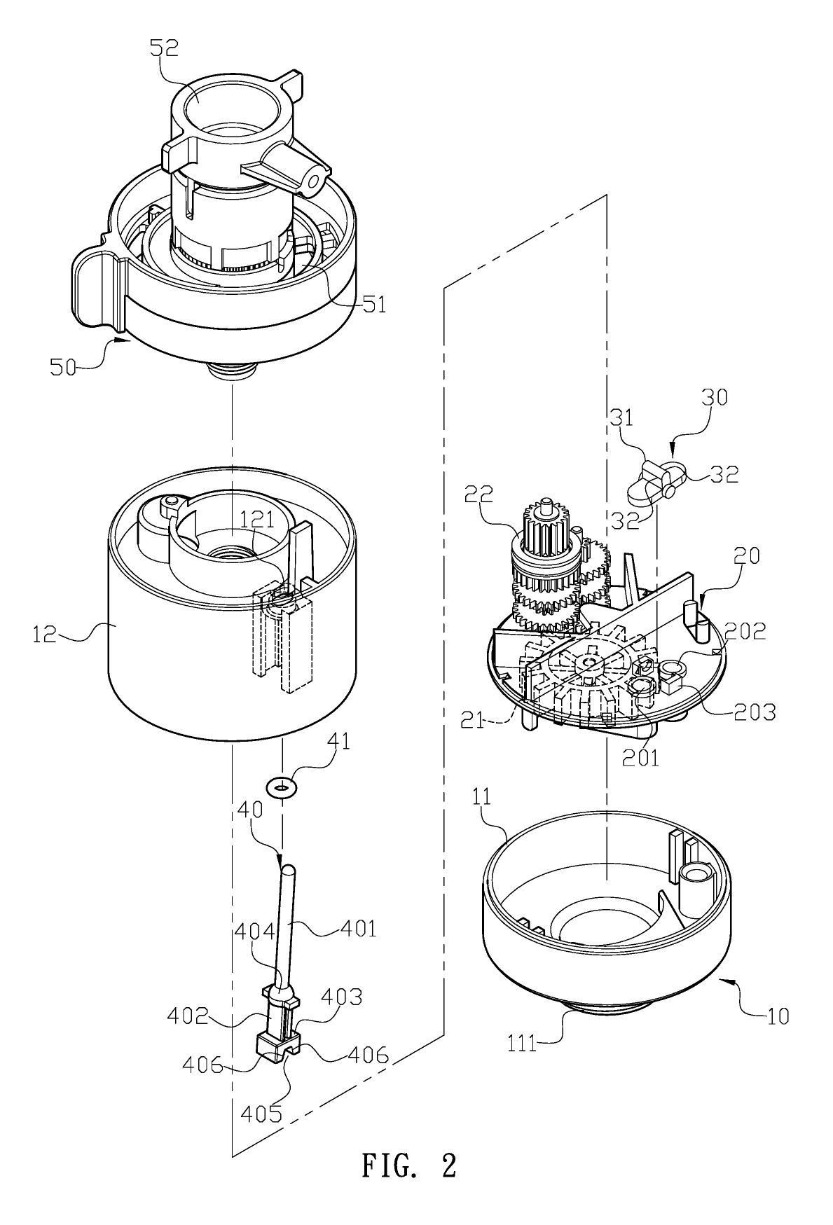

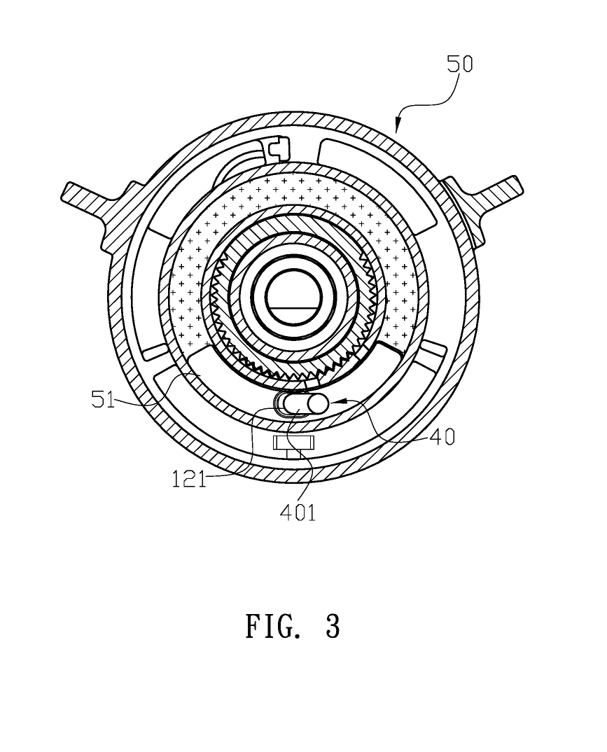

Referring to FIGS. 1 to 5, the present invention provides an irrigation sprinkler which comprises a sprinkler (10), a connecting base (20), an operating member (30), a driving lever (40), and a locating unit (50). The sprinkler (10) has a bottom cover (11) and a top shell (12) which can be vertically fit together, and a water inlet connector (111) is formed at a central portion of the bottom cover (11) for water inflow. Moreover, when the bottom cover (11) and the top shell (12) fit together, an accommodating space is formed therebetween to install the connecting base (20). The connecting base (20) comprises an impeller (21) and a gear set (22) which are respectively formed at a bottom surface and a top surface thereof and are configured to engage with each other to have synchronous movements. A top end of the top shell (12) is connected and communicated with the locating unit (50) through a through hole (121), and the locating unit (50) is adapted to be driven by the gear set (22) to have rotating movement. Furthermore, the locating unit (50) comprises at least two locating grooves (51) having an overlapped area to control a maximum rotating angle of the irrigation sprinkler when spraying water, and a water outlet connector (52) is formed at a top end of the locating unit (50) for water outflow. The connecting base (20) further has a first water channel (201) and a second water channel (202) penetrating therethrough and located adjacent to each other, and two pivotal bases (203) are formed therebetween and respectively at two lateral sides of the first water channel (201) and the second water channel (202) to pivotally connect the operating member (30) thereon. The operating member (30) is pivotally connected to the two pivotal bases (203) through two bumps at two lateral edges thereof, and a protruding portion (31) protrudes from a central portion of a top surface of the operating member (30) between the two bumps. Moreover, the protruding portion (31) has an arc-shaped top end to form two abutting surfaces (32) at two sides of the arc, and one of the two abutting surfaces (32) is configured to be abutted by the driving lever (40) when the irrigation sprinkler changes the rotating direction. Moreover, with the arc-shaped abutting surfaces (32), the operating member (30) driven by the driving lever (40) can be moved smoothly and sensitively. The driving lever (40) has a first portion (401), a second portion (402), and a third portion (403), which are connected sequentially from top to bottom, and a flange (404) is formed between the first portion (401) and the second portion (402). Moreover, a sealing ring (41) is disposed on the driving lever (40) from a top portion thereof to couple with the flange (404), and a bottom end of the third portion (403) has an upward recess (405) formed at a central portion thereof. The diameter of the recess (405) is gradually wider from top to bottom to form two inclined surfaces (406) at two lateral inner surfaces thereof. The sealing ring (41) is configured to couple with an inner wall of the through hole (121), and the first portion (401) of the driving lever (40) sequentially penetrates through the through hole (121) and the overlapped area of the locating grooves (51). The sealing ring (41) in the top shell (11) is configured to limit the position of the driving lever (40) and to provide the sealing effect. Additionally, the protruding portion (31) of the operating member (30) is fully covered by the recess (405) of the third portion (403) of the driving lever (40), and when the irrigation sprinkler is not used, the protruding portion (31) has no contact with the recess (405) to form a separating space (407) therebetween.

In one embodiment, each of the first water channel (201) and the second water channel (202) has two oblique ends.

In another embodiment, the first portion (401), the second portion (402), the third portion (403) and the flange (404) of the driving lever (40) are formed integrally.

In still another embodiment, the third portion (403) and the flange (404) of the driving lever (40) have larger diameters than the second portion (402) thereof.

In a further embodiment, the flange (404) has an arc-shaped top end.

In still a further embodiment, the locating unit (50) comprises two ring bodies coupled with each other, and each of the two ring bodies has at least one locating groove (51), wherein the two ring bodies are configured to be rotated relatively to change the overlapped area of the two locating grooves (51).

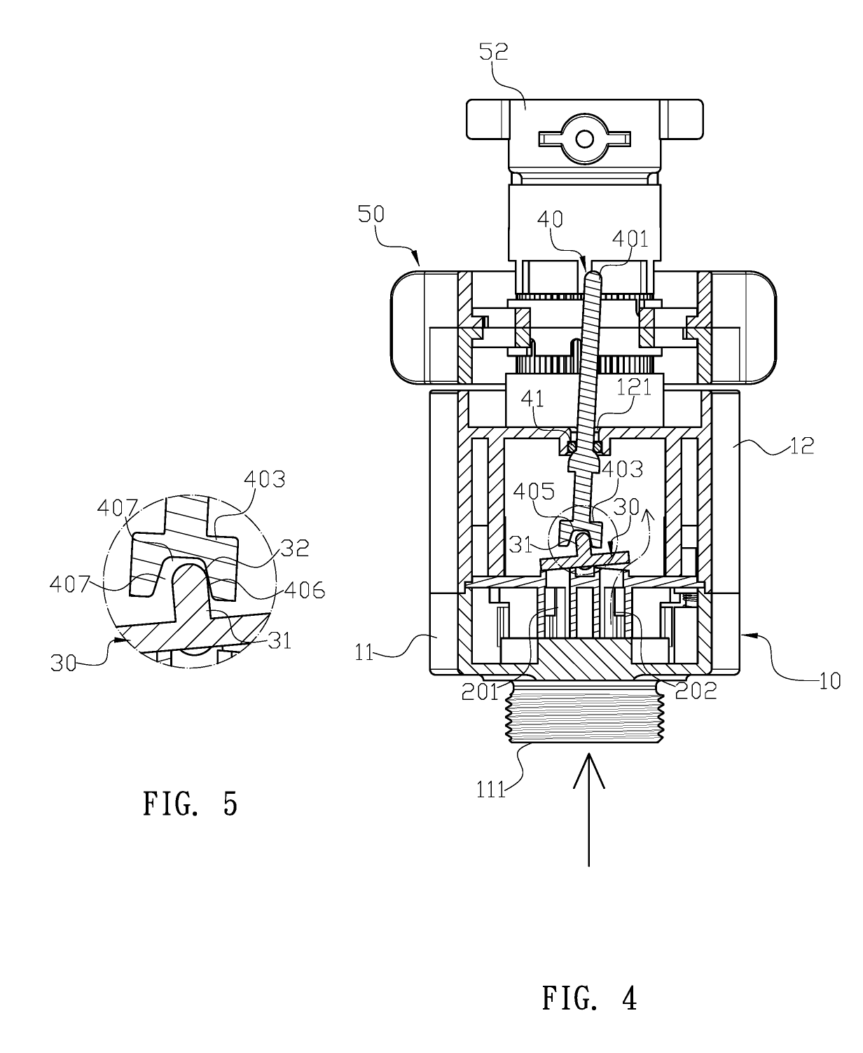

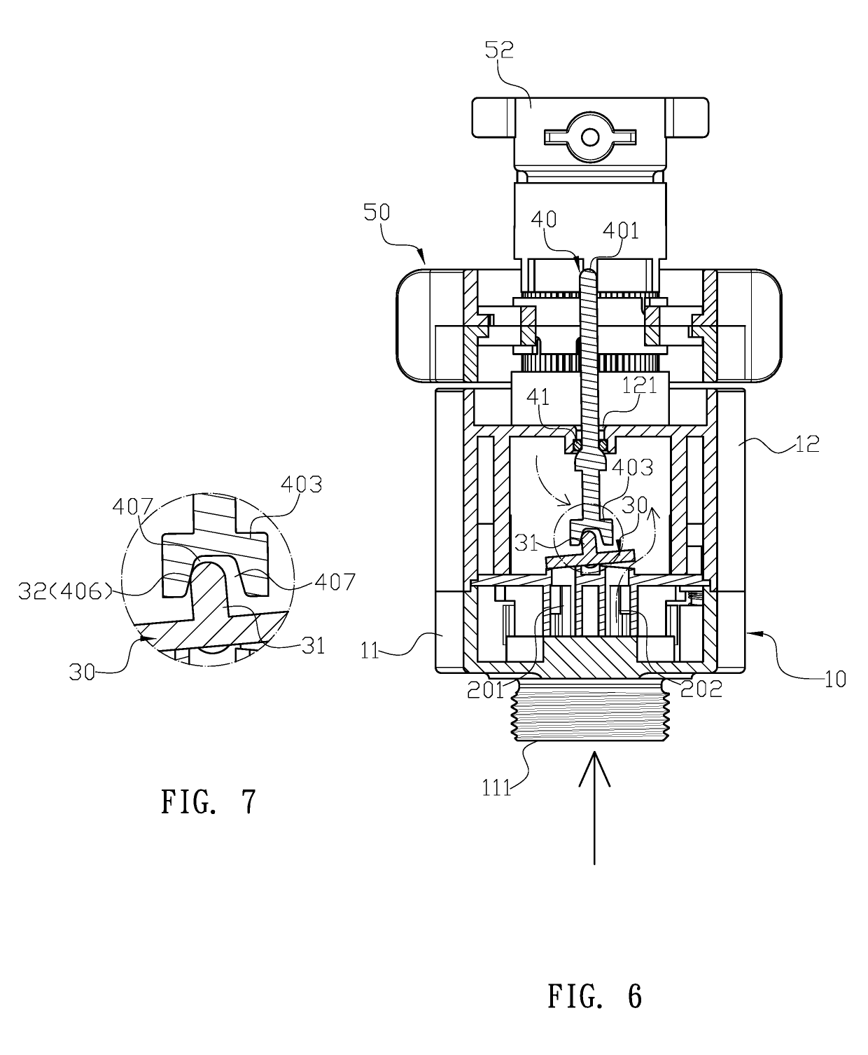

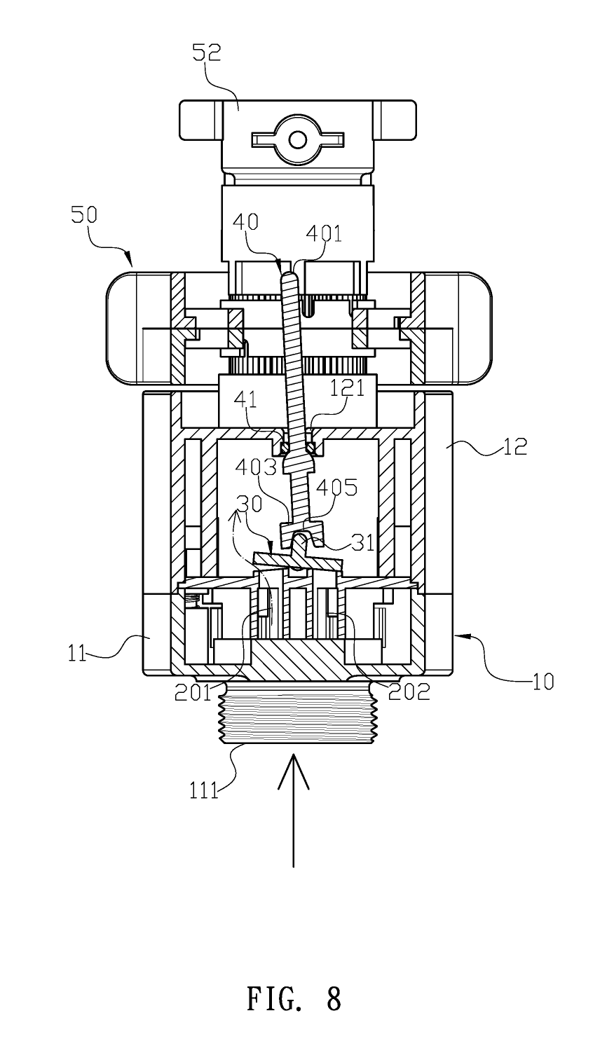

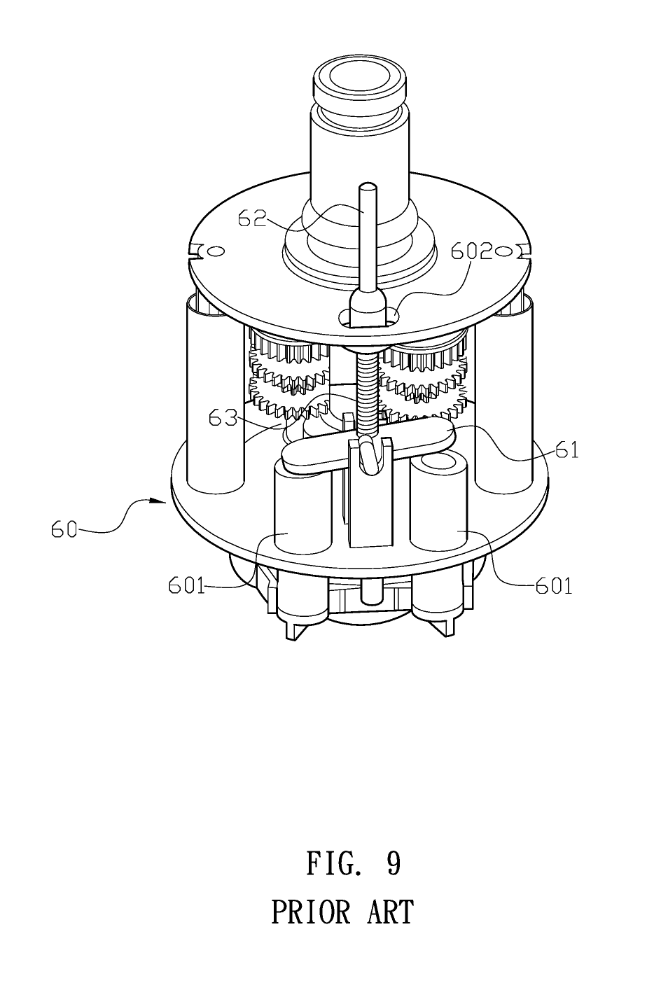

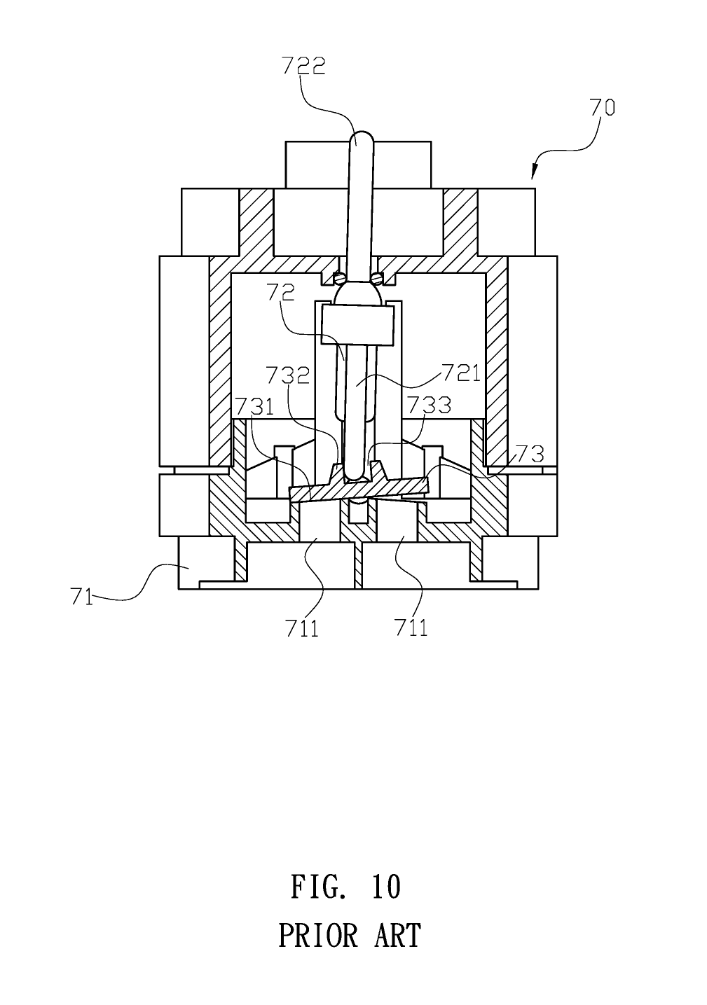

In actual application, when the operating member (30) is tilted toward one side, it can simultaneously block the first water channel (201) and open the second water channel (202) such that water can flow into the connecting base (20) only through the second water channel (202) (as shown in FIG. 4). Meanwhile, the impeller (21) and the gear set (22) driven by the water flow are configured to drive the locating unit (50) to start rotating in a first direction. Furthermore, the locating unit (50) is configured to change rotating direction thereof once a limited rotating angle of the irrigation sprinkler preset by a user is reached. In other word, one of two lateral edges of the overlapped area of the locating grooves (51) is configured to abut against the driving lever (40) when the limited rotating angle of the irrigation sprinkler is reached, and the driving lever (40) is pushed and tilted toward another side, thereby enabling one of the inclined surfaces (406) to push the protruding portion (31) and then tilt the operating member (30) toward another side. Thus, the operating member (30) is configured to open the first water channel (201) and simultaneously block the second water channel (202), thereby changing the direction of water inflow (as shown in FIG. 8). Moreover, when the direction of water inflow is changed, the impeller (21) and the gear set (22) are configured to be rotated inversely, and the locating unit (50) is configured to start rotating in the other direction till the driving lever (40) is pushed by the other lateral edge of the overlapped area of the locating grooves (51), and the rotating direction of the locating unit (50) is configured to be reversed again back in the first direction, thereby achieving the auto reverse effect. Also, when the inclined surface (406) is abutted against the protruding portion (31), the force acts on the arc-shaped abutting surface (32) (as shown in FIGS. 6 and 7), which enables the operating member (30) to be driven smoothly and improves the sensitivity of the irrigation sprinkler when changing rotating direction.

Comparing with conventional irrigation sprinkler, the present invention is advantageous because: (i) the driving lever (40) can be used without a spring, which simplifies the structure, lowers the cost and clears up the worries on rusty spring; (ii) the recess (405) of the third portion (403) of the driving lever (40) completely covers the protruding portion (31), which improves the driving actions between the driving lever (40) and the operating member (30); and (iii) the protruding portion (31) contacts the inclined surfaces (406) through the arc-shaped abutting surface (32), which enables the operating member (30) to be driven by the driving lever (40) more smoothly, further improving the sensitivity of the irrigation sprinkler when changing rotating direction and preventing parts stuck.

Having described the invention by the description and illustrations above, it should be understood that these are exemplary of the invention and are not to be considered as limiting. Accordingly, the invention is not to be considered as limited by the foregoing description, but includes any equivalents.

1. An irrigation sprinkler comprising:
a sprinkler having a bottom cover and a top shell which are configured to vertically fit together, and a water inlet connector formed at a central portion of the bottom cover for water inflow; when the bottom cover and the top shell fitting together, an accommodating space formed therebetween to install a connecting base; the connecting base comprising an impeller and a gear set which are respectively formed at a bottom surface and a top surface thereof and are configured to engage with each other to have synchronous movements; a top end of the top shell connected and communicated with a locating unit through a through hole, and the locating unit adapted to be driven by the gear set to have rotating movement; the locating unit comprising at least two locating grooves having an overlapped area to control a maximum rotating angle of the irrigation sprinkler when spraying water, and a water outlet connector formed at a top end of the locating unit for water outflow;
the connecting base having a first water channel and a second water channel penetrating therethrough and located adjacent to each other, and two pivotal bases formed therebetween and respectively at two lateral sides of the first water channel and the second water channel to pivotally connect an operating member thereon;
the operating member pivotally connected to the two pivotal bases through two bumps at two lateral edges thereof, and a protruding portion protruding from a central portion of a top surface of the operating member between the two bumps; the protruding portion having an arc-shaped top end to form two abutting surfaces at two sides of the arc, and one of the two abutting surfaces configured to be abutted by a driving lever when the irrigation sprinkler changing the rotating direction; with the arc-shaped abutting surfaces, the operating member, which is driven by the driving lever, adapted to be moved smoothly and sensitively; and
the driving lever having a first portion, a second portion, and a third portion, which are connected sequentially from top to bottom, and a flange formed between the first portion and the second portion; a sealing ring disposed on the driving lever from a top portion thereof to couple with the flange, and a bottom end of the third portion having an upward recess formed at a central portion thereof; the diameter of the recess being gradually wider from top to bottom to form two inclined surfaces at two lateral inner surfaces thereof; the sealing ring configured to couple with an inner wall of the through hole, and the first portion of the driving lever sequentially penetrating through the through hole and the overlapped area of the locating grooves; the sealing ring in the top shell adapted to limit the position of the driving lever and to provide the sealing effect; the protruding portion of the operating member fully covered by the recess of the third portion of the driving lever, wherein said recess has a predetermined size and a separating space is formed between the recess and the protruding portion to completely separate the recess and the protruding portion when the irrigation sprinkler is not yet started.

2. The irrigation sprinkler of claim 1, wherein each of the first water channel and the second water channel has two oblique ends.

3. The irrigation sprinkler of claim 1, wherein the first portion, the second portion, the third portion and the flange of the driving lever are formed integrally.

4. The irrigation sprinkler of claim 1, wherein the third portion and the flange of the driving lever have larger diameters than the second portion thereof.

5. The irrigation sprinkler of claim 1, wherein the flange has an arc-shaped top end.

6. The irrigation sprinkler of claim 1, wherein the locating unit comprises two ring bodies coupled with each other, and each of the two ring bodies has at least one locating groove, and the two ring bodies are configured to be rotated relatively to change the overlapped area of the two locating grooves.
